(19) United States
(12) Patent Application Publication
(10) Pub. No.: US 2017/0364911 A1
(43) Pub. Date: Dec. 21, 2017

(54) SYSTEMS AND METHOD FOR ENABLING SECURE TRANSACTION

(71) Applicant: Cryptomathic Ltd, Cambridge, Cambridgeshire (GB)

(72) Inventors: Mads Landrok, San Jose, CA (US); Peter Landrock, Cambridge, Cambridgeshire (GB)

(21) Appl. No.: 15/534,989

(22) PCT Filed: Dec. 10, 2015
(86) PCT No.: PCT/GB2015/053806

§ 371 Date: Jun. 9, 2017

(30) Foreign Application Priority Data
Dec. 12, 2014 (GB) 1422158.4

(51) Int. Cl. G06Q 20/38; G06Q 20/42; G06Q 20/34; G06Q 20/40

(52) U.S. Cl. CPC G06Q 20/3823; G06Q 20/4012; G06Q 20/3829; G06Q 20/42; G06Q 20/351; G06Q 20/3825; G06Q 2220/00

(57) ABSTRACT

Embodiments of the present invention provide systems and methods of generating a secure transaction, particularly when the transaction is made using a mobile computing device. This is achieved by eliminating the need for cryptographic keys to be stored on the mobile computing device, by firstly creating a strong link between users and their devices, and storing this pre-defined link with a trusted authentication service (i.e. in a secure backend payment system), and secondly using the pre-defined link between user and device to generate a unique, electronic or digital signature for a transaction which will authorise a payment, wherein the digital signature having been generated by using authentication information comprising a first authentication identifier and a second authentication identifier.

### FIELD OF THE INVENTION

The invention relates to a system and method for generating a secure transaction.

### BACKGROUND TO THE INVENTION

Typically, individuals buy products or services in shops and stores using credit or debit cards. When paying for a product with an EMV card (or “chip and PIN” card), users are required to enter a PIN to authenticate they are the cardholder before the transaction can be completed. Each EMV card has an embedded microchip which, when the card is placed into a point of sale (POS) terminal, connects to the terminal. The POS terminal may be connected to bank servers via a communication network. The cardholder enters the PIN associated with the card into the POS terminal. In the case the POS terminal is connected to bank servers, the PIN and other details stored in the microchip may be transmitted to the bank servers for authentication. In the case the POS terminal is not connected to a network, the microchip itself can verify if the PIN was entered correctly (by comparing the PIN with information stored in the microchip). In both cases, some or all of the information required to authenticate the cardholder is held on the card itself, and a user must enter their PIN every time they use the EMV card.

Similarly, when individuals buy products or services via online stores (i.e. via internet shopping), they must enter many of the details held on their EMV cards, such as the 16 digit bank card number, the start date of the card, the expiry date of the card, and the card security code (CSC) or card verification code (CVC or CVC2). In such “card not present” transactions, it is not possible to provide a POS terminal for a user to enter their PIN. Instead, card-issuing banks may provide software solutions to increase the security of online transactions, such as “Verified by Visa” and “MasterCard SecureCode”. Such software solutions typically require cardholders to set an alphanumeric passcode for their card (during a registration phase) and then to enter randomly selected characters of the passcode during a transaction to authenticate the cardholders. However, it is possible for spyware and key-logging software to determine a user's passcode after only a few transactions.

An example of a method and apparatus for requesting and providing a digital signature is described in UK Patent Application No. GB1310468.2 and PCT Patent Application No. PCT/GB2014/051749, both of which are incorporated herein by reference in their entirety. PCT/GB2014/051749 describes a system for generating a signature for a user which comprises a signature server, an initial transaction device for a user and a validation device for a user. The initial transaction device is configured to display a first message M and send a request to the signature server to create a signature for the first message M. The signature server is configured to generate a validation challenge using a second message M′ which is based on the first message M and a first secret shared between the user and the signature server and send the validation challenge to the validation device. The validation device is configured to regenerate the second message M′ using the first shared secret, display the second message M′, receive user confirmation that the displayed second message M′ corresponds to the first message M, generate a validation code confirming the request to create a signature; and send the validation code to the signature server. Thereafter, the signature server generates the signature for the user for the first message M. However, this system necessitates two user devices—one which performs a transaction and one which generates a validation code—which are preferably separate from one another. The signature server, and an authentication server attached to the signature server, require the validation code to be generated by and received from the validation device for security purposes.

Further background information can be found in US2013/0226812, which is incorporated herein by reference in its entirety. US2013/0226812 describes a secure payment system comprising a payment transaction proxy, which is authorised by users to make payments for them. A user uses a computing device to receive transaction details from a point of sale terminal and, if the details are correct, uses the device to authorise the payment transaction proxy to complete the transaction on his behalf. The payment transaction proxy overcomes the need for the user to present their EMV card to perform a transaction.

The present applicant has recognised the need for an improved method to provide digital signatures to, for example, improve security when performing transactions, and in particular, to provide improved security using mobile devices, such as smartphones, laptops, tablets or similar devices.

### SUMMARY OF THE INVENTION

According to a first aspect of the invention there is provided a method of generating a secure transaction on behalf of a user having a user device, the method comprising:
using authentication information to authenticate the user device, the authentication information comprising a first portion for authenticating the user device and a second portion for authenticating a message from the user device;
receiving a request from the user device to initiate a secure transaction via a first communication channel;
receiving a first authentication identifier from the user device wherein the first authentication identifier is based on the first portion of the authentication information;
receiving a message comprising transaction details from the user device via the first communication channel;
receiving a second authentication identifier from the user device wherein the second authentication identifier is based on the message and the second portion of the authentication information;
determining whether the first and second authentication identifier are authentic and only if both authentication identifier are authentic; the method further comprises:
generating secure information which is unique to the user for the secure transaction; and
outputting the secure information whereby the secure information is used secure the secure transaction.

The authentication challenge and secure information are preferably generated in a secure backend payment system.

Thus, according to a second aspect of the invention, there is provided a secure backend payment system for generating a secure transaction on behalf of a user having a user device, the system being configured to:
use authentication information to authenticate the user device, the authentication information comprising a first portion for authenticating the user device and a second portion for authenticating a message from the user device;
receive a request from the user device to initiate a secure transaction via a first communication channel;
receive a first authentication identifier from the user device wherein the first authentication identifier is based on the first portion of the authentication information;
receive a message comprising transaction details from the user device via the first communication channel;
receive a second authentication identifier from the user device wherein the second authentication identifier is based on the message and the second portion of the authentication information;
determine whether the first and second authentication identifier are authentic and only if both authentication identifier are authentic; the method further comprises:
generate secure information which is unique to the user for the secure transaction; and
output the secure information whereby the secure information is used secure the secure transaction.

The following features apply to both aspects of the invention.

The authentication information may be an authentication challenge which is generated in response to the user request. In this case, the method may further comprise generating the authentication challenge, in response to the request from the user device; sending the authentication challenge to the user device via a second communication channel which is different to said first communication channel; receiving a first response to the authentication challenge from the user device wherein the first response is the first authentication identifier; and receiving a second response to the authentication challenge from the user device wherein the second response is the second authentication identifier. Alternatively, the authentication information may be shared with the user device before the request is received, e.g. on registration.

The system may comprise an authentication server and a signature server which share the required functionality. For example, the authentication server may generate and send the authentication challenge as required/authentication information on registration, and receive and authenticate the responses. The signature server may generate—from transaction details forwarded by the user—and send out the secure information. It will be appreciated that the authentication server may receive the request from the user device or that the request may be sent to the signature server which then sends instructions to the authentication server. (The signature server is also referred to herein as an electronic signature generation module, or as a one-time-use bankcard details generator.) The authentication server and signature server may be physically and functionally separated from one another. The authentication server and signature server may be coupled together in a safe environment with secured communication channels between them. Additionally or alternatively, the functionality of the authentication server and signature server could be provided by a single, central secure server.

Generally speaking the present invention provide systems and methods to define a relationship between users and their computing devices in a secure payment authorisation system, and use this relationship to generate a digital signature or one-time-use payment information for a transaction that will authorise the transaction without the use of a physical debit or credit card. The secure information may be sent to the user device which then uses the secure information, together with the original transaction details to create a secure transaction. Alternatively, the secure information together with the transaction details may be sent to a third party, e.g. the bank or shop.

A user and his device are pre-registered in the secure backend payment system. The steps to register the user and device, and to thereby define a relationship between them, are described in more detail below.

When a user wishes to buy an item or service, rather than paying for the item with a physical debit or credit card, the user preferably uses his registered device to obtain an electronic signature or other secure payment information to execute the transaction. This avoids the need for the user to enter the details written on his debit or credit card at any point during the transaction.

Obtaining the electronic signature or payment information requires a user to be authenticated, and the device from which the request for an electronic signature is received to be authenticated. In embodiments, the device authentication may be a two-step process: firstly, the system verifies that the transaction request is coming from a registered device and not a spoof account, and secondly, the system verifies that the transaction request has been cryptographically secured using the correct secret key and that the transaction details have not been altered during transmission (e.g. via a man in the middle attack).

The authentication and signature servers (or a single server capable of performing both functions), are tamper resistant, typically employing a Hardware Security Module (HSM) with a limited command set available. The signature server may, in embodiments, contain the private keys of different users, initiated in such a way that only the rightful owner can initiate signature generation with his own private key.

The present method and system provide advantages of reduced cost of administration of the authentication server, increased ease of use for the users, and increased security, as the information unique to the user never leaves the signature server of the authentication server, whether in encrypted form or not. This allows the user to use multiple workstations without carrying their private key to each workstation. Therefore, only a breach of the signature server can result in the private keys being made available outside the signature server, which consequently must be prevented using tamper resistant hardware designed for the purpose (such as the IBM 4758, IBM 4764, IBM Crypto Express3, IBM 4807, IBM 4808, IBM 4809 or IBM 4765).

In more advanced scenarios, the private key could actually be distributed between any number N of servers using what is known as “secret sharing” in such a way that they each have a component of the key by which they can calculate an input for the generation of the signature, which is supplied back to the source device, where the full digital signature is then calculated from K inputs where K is some number between 2 and N. The advantage of this is that at least K servers would have to be compromised before an attacker could calculate the private key.

The authentication server or authentication apparatus may include anything which is centrally based, and accessible from one or more source devices. The authentication server may comprise a signature server or may be separate therefrom. The authentication server may be accessible from many source devices (or user devices). The authentication server may generate authentication challenges and transmit these to a user device. The authentication server may receive a response to the authentication challenge from the user device, but may forward this response to the signature server for verification. Thus, the function of the authentication server is to register user and device IDs, authenticate users and devices, and optionally, provide keys for communication between devices and the signature server. However, the authentication server preferably does not read transaction data/details received from the user device but instead passes this data on to the signature server for validation and processing.

The user device may typically be a workstation, but may also be an Automated Teller Machine for supplying cash, a PC, laptop, smartphone, or tablet-PC. The user device will have all software required to communicate effectively with the authentication server, but this could be supplied or downloaded to the user device for the required duration of interaction only. The user device allows communication with the authentication server.

The first and second channels are preferably separate from one another. For example, one channel may be via SMS and another via the internet. Alternatively, secure communication tunnels could be formed. The user device and authentication server may establish an authenticated connection between them before and during transfer of transaction data and authentication data. Additionally, the connection may be encrypted. This reduces the possibility that the connection will be intercepted or interfered with.

The first portion of the authentication information may be a passcode and/or the second portion may be a shared cryptographic key. It will be appreciated that these are merely examples of suitable authentication information and other known techniques can be used. It is important that there are two separate portions; the first which authenticates the user device to avoid a third party spoofing the user device and the second which authenticates the message to ensure that the message is not intercepted and tampered with.

Where a shared cryptographic key is used, the second authentication identifier may be a message authentication code which is generated by the user device by applying the shared cryptographic key to the message. The second authentication identifier may then be checked for authenticity by applying the shared cryptographic key to the received message to generate a message authentication code, comparing the generated code to the received code and determining the second authentication identifier is authentic when the codes match. Examples of shared cryptographic keys include a strong triple-DES or AES key. Alternatively, the shared cryptographic key may comprise a key hash value or an encrypted hash value. As set out above, these are examples of suitable techniques. These keys may be shared on registration or by the use of authentication challenges.

The second portion of the authentication information may comprise the private key of a public key—private key pair specific to the user. The signature server may generate a digital signature specific to the user, based on data supplied by the user. Such keys and digital signatures provide high security as they are very hard to decrypt fraudulently.

When the first portion comprises a passcode, the first authentication identifier may simply be the passcode. Where the first authentication identifier is generated as a response to an authentication challenge, this need not be encrypted and could be in plaintext. This step is simply used to verify that the authentication challenge has been received by the correct user device. Determining whether the first response is authentic may comprise comparing the received passcode with the sent passcode, thereby determining the request originated from the user device is the received and sent passcodes match. If cryptographic techniques are used, this determining step will need adjusting accordingly. For example, where the first authentication identifier is generated based on a passcode which is exchanged at registration, the passcode (or token) needs to be kept secret. Accordingly, the first authentication identifier may be a one-time-password generated by the user device using any known technique. Determining whether the first authentication identifier is authentic can be done by regenerating the one-time-password from the passcode (i.e. by the authentication server applying the same technique to the passcode as that used by the user device), comparing the regenerated one-time-password with the received one-time-password, thereby determining the request originated from the user device when the one-time-passwords match.

A verification message may be sent to the user prior to generating the secure information for the secure transaction, wherein the verification message comprises the received transaction details. This verification message may be sent to the user device over the second communication channel or to a second user device which is separate from the user device. The verification message provides a final check in the method to allow a user to confirm that they wish the secure transaction to take place.

The secure information may be an electronic signature. By generating the signature at the signature server, the sensitive information which is specific to the user and which is used to generate the signature is securely stored. Storing this information on a user device is more risky.

The secure information may be virtual card details. The virtual card details may be linked to a bank account for the user and the secure transaction being performed. The virtual card details may be valid for a pre-set time period, wherein the method further comprises sending the pre-set time period to the user device with the virtual bankcard details. The method of generating virtual card details may be used together with the above features or as a standalone feature.

Thus according to another aspect of the invention, there is provided a method of generating virtual bankcard details for a secure transaction on behalf of a user having a user device, the method comprising:
receiving a request from the user device to initiate a secure transaction via a first communication channel;
generating the virtual bankcard details for the secure transaction; and
sending the virtual bankcard details to the user device via the second communication channel.

Again, this method may be carried out in a signature server.

As set out above, the authentication server may be part of a secure backend payment system. The following features apply to all aspects of the invention.

The system may further comprise a data store storing pre-defined relationships between each user and their user device.

The system may further comprise a user device comprising:
a user interface for displaying a message comprising details of a transaction to the user;
a transaction processing module for initiating a secure transaction session between the computing device and the third party on a first communication channel; and
an authentication module configured to:
   receive the authentication information and
   generate the first and second authentication identifiers.

The system may further comprise a second user device which is configured to:
receive a verification message prior to the signature server generating the secure information for the secure transaction, and
generate a response to the verification response.

The invention further provides processor control code to implement the above-described systems and methods, for example on a general purpose computer system or on a digital signal processor (DSP). The method is thus a computer-implemented method which runs on a processor and the system and/or each server may comprise a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), etc. The or each processor may include one or more processing cores with each core configured to perform independently. The or each processor may have connectivity to a bus to execute instructions and process information stored in, for example, a memory.

The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

### BRIEF DESCRIPTION OF THE DRAWINGS

The invention is diagrammatically illustrated, by way of example, in the accompanying drawings, in which:

FIG. 1 illustrates a schematic of a secure payment system according to embodiments of the present invention;

FIG. 2a is a block diagram of a system to process secure payments in an embodiment of the present invention;

FIG. 2b is a block diagram showing an authentication server and a signature server in an embodiment of the present invention;

FIG. 3 is a flow chart of example steps for a user to register to use the secure payment system of FIG. 2a;

FIG. 4 is a flow chart of example steps to make a purchase in a store;

FIG. 5 is a flow chart of example steps to make a purchase in an online store;

FIG. 6 is a flow chart of example steps to make a purchase in an online store in a further embodiment of the present invention; and

FIG. 7 is a block diagram of a system to process secure payments using the method of FIG. 6.

### DETAILED DESCRIPTION OF THE DRAWINGS

Broadly speaking, embodiments of the present invention provide systems and methods to define a relationship between users and their computing devices in a secure payment authorisation system, and use this relationship to generate a digital signature or one-time-use payment information for a transaction that will authorise the transaction.

As mentioned above, there are two general types of transaction: ‘card present’ transactions (e.g. when a bank card is presented to a point of sale (POS) terminal to make a transaction) and ‘card not present’ transactions (e.g. for online-banking transactions, where a physical card does not need to be presented to make a transaction). In both cases, a user either presents a card holding many of their bank details to a POS terminal, or a user manually enters many of their card users to make a purchase online. PINs may be intercepted at or via POS terminals and secure passcodes associated with bank cards may be determined after a user has made a few online transactions. For example, online transactions usually require users to key in most of the details written on his debit or credit card, which invites ‘card not present’ attacks. The only currently adapted countermeasure against this is “3D Secure”, the software protocol designed to provide an additional security step for online transactions. However, this is a weak measure because it requires a user to create a passcode that he can remember, all of which will typically have been revealed after relatively few purchases, perhaps after only one use.

Consequently, the present invention seeks to provide methods and systems of performing transactions which do not require users to provide their bank card details for a transaction. Rather, such details are held in a secure backend system and the user merely needs to confirm their identity in some way in order for the transaction to complete.

More and more individuals use mobile computing devices (e.g. smartphones, tablets, PCs, etc.) to make phone calls, send emails, and to make purchases online. However, the risk of performing transactions on a mobile device is high and typically, attempts to lower the risk have involved using specialised security hardware (e.g. a Chip Authentication Program or “CAP” card reader) in combination with the mobile device, which allows the user to use, but not to reveal his keys.

In 2003, Cryptomathic Ltd was recognized by the World Economic Forum in Davos in Switzerland as a technology pioneer for its innovations in establishing the virtual chipcard for the generation of digital signatures on documents with legal value. At the time, the focus was on electronic signatures which would reside on a service which could be used, but never revealed and only based on strong authentication of the user and/or his security token.

Today's mobile computing devices are generally uniquely identifiable, which advantageously means the devices have the inherent ability to authenticate themselves and be authenticated. However, from a security and threat perspective, mobile devices are nothing but connected, personal computers with the shortcoming associated therewith. Specifically mobile devices are viewed as non-protected and non-isolated memory space, which makes such devices all too vulnerable to attacks aimed at stealing the cryptographic keys stored on such devices.

The present invention may be thought of as a method that enables secure payments to be made using standard mobile devices such as smartphones or tablets, but without requiring cryptographic keys to be stored on such devices to secure the transaction.

The first half of the solution to the above-described security problem is to create a strong binding or link between users and their devices, and storing this pre-defined link within a trusted authentication service (i.e. in a secure backend payment system). The second half of the solution is to use the pre-defined link between user and device to generate a unique, electronic or digital signature for a transaction which will authorise a payment. The pre-defined (registered) relationship between user and device permits access to using security keys in another high-availability, secure service (i.e. a secure service which generates digital signatures for transaction, denoted a signature server) while not revealing the keys or requiring a user to enter keys or other vulnerable bank details to perform a transaction.

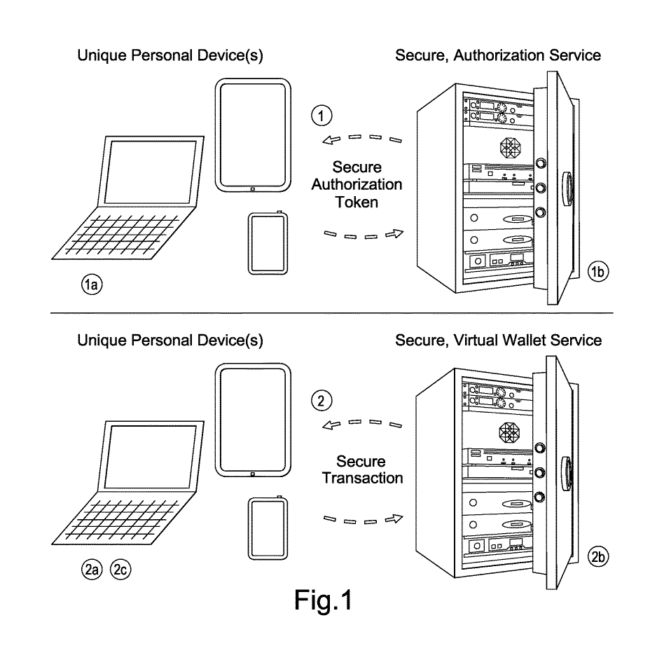

FIG. 1 illustrates a schematic of a secure payment system according to embodiments of the present invention. The secure backend payment system or server comprises a digital signature server and optionally an authentication server. The digital signature server produces the same output as would have been produced by the user had he used an EMV bankcard. However, advantageously, the key needed to create this output is stored securely on the backend server and never leaves it. Thus, a user does not need to present their EMV bankcard at a point of sale terminal to make a transaction, because the details that are usually stored on the card are instead accessed from the secure backend system to authenticate the cardholder. Similarly, a user making an online transaction does not need to provide all the details provided on their bankcard.

As mentioned earlier, typically a user's personal credit or debit card details (e.g. a PIN and other authentication information) is stored on the embedded microchip on the card itself. The authentication process is often performed via the chip of the credit card. In embodiments, the authentication process can be performed in a secure environment instead, i.e. in the secure backend. The secure environment may be in the cloud or a remote server.

As shown in FIG. 1, two key steps are required to permit a user to use the secure payment system. In the first step, a unique, secure authorisation token is generated which links together a user's personal computing device(s) 1a (e.g. laptop, smartphone, tablet PC, etc.) and a secure authorisation service 1b. The security token is typically a software-based token, which is unique to each computing device registered to use the secure payment system, and is used to prove the identity of the device during a transaction. The token may be a static token or a dynamic password token. The token may be based on unique existing authentication information (e.g. cryptographic key(s)) obtained from the user and/or his computing device. For example, computing device 1a may comprise hardware protected cryptographic keys, such as, for example, a trusted platform module (TPM) chip or a digital rights management (DRM) chip. The token may also be based on unique authentication information (e.g. cryptographic key(s)) held for the user (and owner of the device) on the secure authorisation service 1b.

Once a secure token or relationship is defined between a user, user device and authorisation service, a user can make a secure transaction using this relationship or token. This may involve a user device 2a, 2c communicating with a secure ‘virtual wallet’ service or digital signature generating service 2b. The virtual wallet service has the same functionality as the embedded microchip on an EMV card—it hosts the user's security applications and will allow for the use of the secure tokens to, for example, generate a payment authorisation cryptogram. Thus, in embodiments the system provides a virtual chip or EMV card. Advantageously, the user may perform transactions in stores and online without using their bankcard or entering any details of their bankcard during the transaction process.

If the computing device registered in the system becomes compromised or is stolen, the user is not protected against a third party using the device to perform unauthorised transactions. Thus, preferably the system requires an additional authorisation step to verify if the person attempting to make a transaction using the mobile device is the user associated with the device or a third party. This additional authorisation step may comprise notifying the user via secondary channels about the transactions being carried out and asking the users to confirm the transactions. For example, an interactive voice response system (IVR system) may be used to ask a user to confirm the transaction. Additionally or alternatively the authorisation may comprise biometric analysis (e.g. fingerprint scanning, facial recognition) to confirm the person making the transaction is the registered user of the device.

The backend payment scheme server enables a cryptographically authorised transaction of a particular payment scheme to be performed (such as CAP (MasterCard) or DPA (VISA) as well as EMV static data authentication (SDA), EMV dynamic data authentication (DDA) or EMV combined data authentication (CDA)). That is, the backend payment system provides the same functionality as is currently provided on a debit or credit chip card. Advantageously, no protocol replacement is required for the backend payment scheme—POS terminals and online vendors still receive the information they require from the user to process and complete a transaction, except that the information is acquired from the backend system rather than from the user's chip card. Thus, embodiments of the present invention provide a completely and radically different underlying architecture to generate digital signatures for transactions.

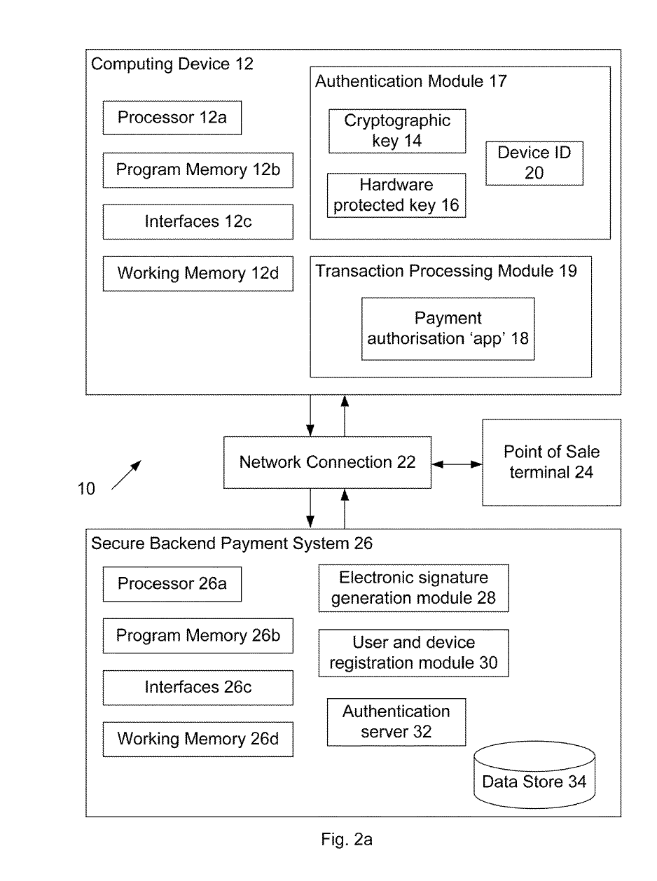

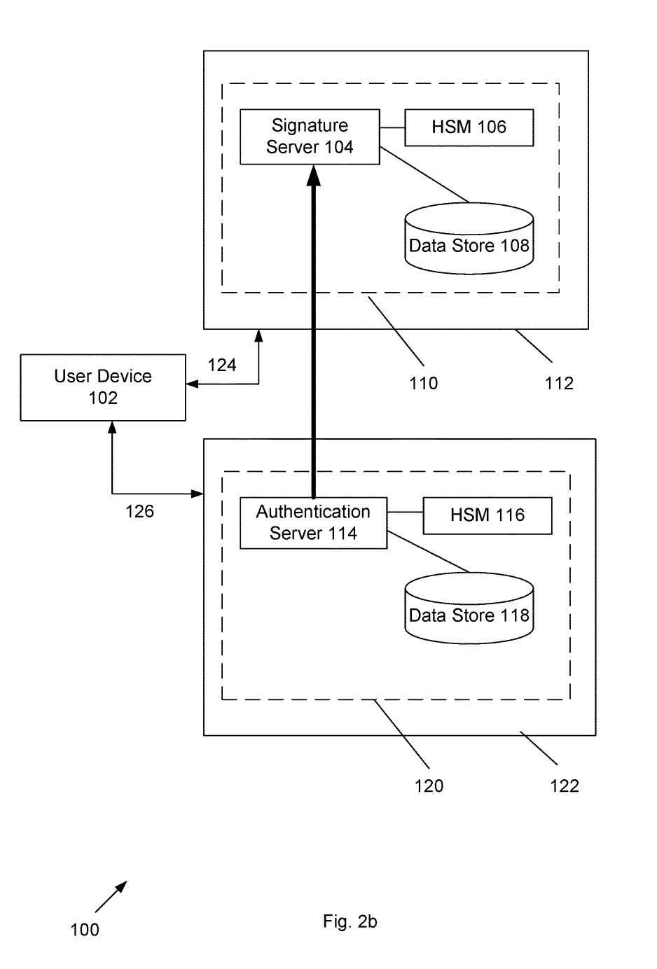

Turning now to FIG. 2a, this shows a block diagram of a system 10 to process payments securely. A user uses a computing device 12 to perform transactions in store and/or online. The computing device may be a PC or preferably, a mobile computing device, such as a laptop, smartphone, tablet-PC, etc. The computing device comprises a processor 12a coupled to program memory 12b storing computer program code to implement the backend payment method, to working memory 12d and to interfaces 12c such as a screen, keyboard, mouse, touchscreen, and network interface.

The processor 12a may be an ARM® device. The program memory 12b, in embodiments, stores processor control code to implement functions, including an operating system, various types of wireless and wired interface, storage and import and export from the device.

The computing device 12 comprises a user interface to enable the user to confirm transactions. A wireless interface, for example a Bluetooth®, Wi-Fi or near field communication (NFC) interface is provided for interfacing with other devices, such as point of sale terminals.

The computing device 12 may comprise a cryptographic key 14 or hardware protected key 16, used to cryptographically secure details of transactions transmitted to a secure backend payment system 26. The key may be temporarily provided to the computing device 12 for use with a particular transaction, or may be stored within the computing device. The computing device comprises payment authorisation software, preferably in the form of a software application (‘app’) 18. A user is preferably required to turn on the payment authorisation app 18 when initiating a transaction using the secure system. The payment authorisation app 18 is a part of a transaction processing module 19. The computing device 12 also comprises a device ID 20, which uniquely identifies the device, and is used to define the relationship between user and device which is stored within the system. The device ID 20 may be the unique ID associated with the hardware-based computing device 12, and/or if the computing device is able to connect to a mobile communication network, the device ID may be the subscriber identity module (SIM) which identifies the device on the mobile network. As such, the computing device comprises an authentication module 17 which is configured to receive the authentication information and generate the first and second authentication identifiers.

The computing device 12 may be used by a user to perform an online transaction through, for example, web browser software running on the device. Additionally or alternatively the computing device may be used with a terminal such as an automated teller machine (ATM) or POS terminal that has Bluetooth® or NFC communication capabilities. Thus, the computing device 12 may communicate with an online vendor, and/or with a POS terminal 24 in a physical store via the appropriate network connection 22.

The transaction details of a particular transaction being performed by the user using the computing device 12 are forwarded to a secure payment backend server 26 via the network connection 22.

The secure backend payment system 26 comprises at least one processor 26a coupled to program memory 26b storing computer program code to implement the backend payment method, to working memory 26d and to interfaces 26c such as a network interface. The secure backend payment system 26 comprises an electronic or digital signature generation module or server 28, a user and device registration module 30 and an authentication server 32. The electronic signature generation module 28 is used to generate digital signatures (e.g. a payment authorisation cryptogram), thereby providing a virtual chip card that has the same functionality as a physical chip card or EMV card.

The user and device registration module 30 is used to create the strong binding or secure authorisation token between a user and user device(s), as mentioned above. Once this relationship between user and user device is defined in the registration module 30 (and stored in a data store 34), the relationship can be used to authorise subsequent transactions. This authorisation is performed by the authentication server 32, which checks whether a registered user is attempting to make a transaction on his registered device. The authentication server may perform this check by referring to the pre-defined data held for the user in the data store 34. The authentication server may perform additional authentication checks to confirm the user's identity, as will be described in more detail below, where such additional checks may also be pre-defined for the user in the data store 34.

Thus, embodiments provide a way to identify a user and his computing device properly, as well as ways to prevent ‘Man-in-the-Middle’ or ‘Man-in-the-Browser’ attacks where parts or all of the transaction data forwarded by the user are altered by a third party. Typically, the steps to prevent such attacks comprise an initial ‘verification’ protocol that establishes whether the device being used to perform a transaction is a registered device belonging to a registered user, and that the device is being used by someone who knows some secrets that are shared between the registered user and the backend authentication server. This initial step is generally followed by creating a session in which the user forwards the details of a transaction to the secure backend payment system and authorises the transaction to be completed.

As shown in FIG. 2a, a computing device 12 may comprise a device ID 20 which is used to identify the device. There are a number of ways of identifying a computing device or mobile computing device, e.g. using cookies and device IDs. Similarly, there are a number of methods for identifying a user. For example, a user could be authenticated by requiring the user to enter a pre-set static password over multi-factor authentication methods. The user could, for instance, be required to forward a one-time passcode (OTP) via an SMS message to the authentication server 32 if the mobile device 12 is a smartphone or is a device running an OTP application on the phone in software.

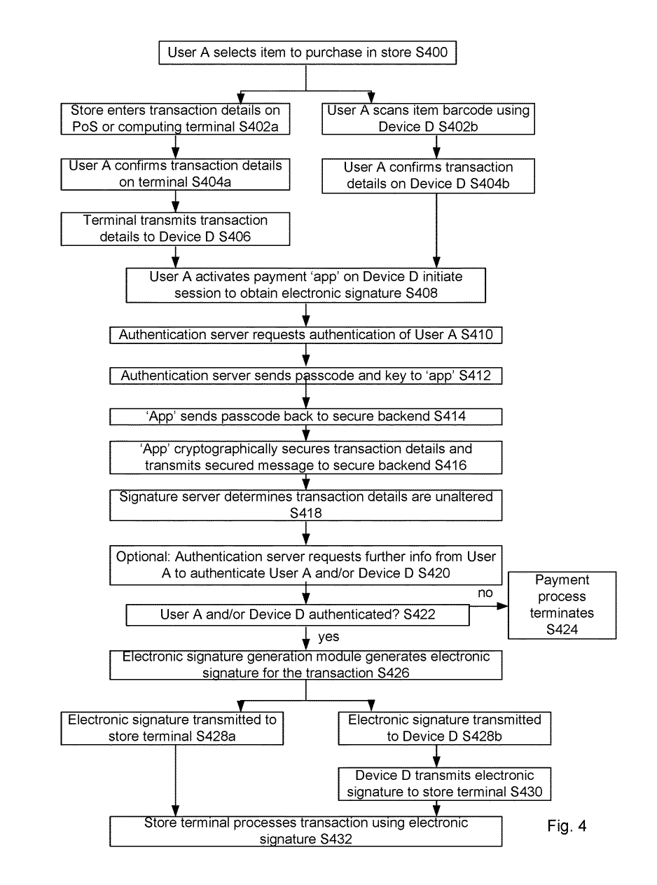

Data may be transferred from the computing device 12 to the secure backend payment scheme 26 (via the network connection 22) for authorisation in a number of ways. In one realisation, if a smartphone is used, the transaction could just be forwarded in plaintext, and if the monetary amount is above a certain limit, a computerised call back could take place where the most important details are read to the user together with an authorisation code that he then keys in on his computing device 12. Alternatively, the transaction data could be forwarded in a cryptographically secure form using an appropriate key which was provided to the computing device 12 by the secure backend payment system 26. An example of how to use the secure system 10 to make transactions is described in more detail below with respect to FIG. 4.

FIG. 2b is a block diagram showing the secure backend payment system 100 comprising an authentication server 114 and a signature server 104 in an embodiment of the present invention. A user device 102 (e.g. a computing device or mobile computing device) is coupled to a certifying device, which in the present embodiment is signature server 104, via a communication line 124. The communication line 124 is not inherently secure. The user device 102 may be any terminal at which communication may be established with the signature server 104. The signature server 104 may securely store the private keys of each user, and may additionally log some or all relevant information regarding users and their activities. The signature server 104 handles requests from users via the workstation 102. The signature server 104 is ideally certified to an International standard, such as FIPS 140-1 level 3 or 4 (see FIPS Pub 140-1, 1994. National Institute of Standards & Technology, USA), which is a generally accepted standard to indicate the quality of the tamper resistance features of the hardware protection of the server.

The signature server 104 receives data, which is to be authenticated as originating from the user, from the workstation 102. Authentication may, in embodiments where public-private key pairs are used, be achieved using the private key of the user, which is stored on the signature server 104, to decrypt data received from the workstation 102, and then generate an electronic signature or virtual payment information as described in more detail below.

In addition to the signature server 104, in an embodiment of the present embodiment the certifying device also comprises a separate authentication server 114, which is enhanced by tamper resistant hardware just as the signature server 104. Alternatively, the authentication server 114 may be remote to the signature server 104, but still within a safe, secure environment. Alternatively, the functions of the signature sever and authentication server may be provided by a single central server. The signature server 104 is connected to the authentication server 114 via a strong cryptographic link (i.e. encrypted and authenticated), for example by a shared master key, or based on public key encryption-decryption, using standard solutions, also sometimes known as a VPN (virtual private network). This is used to establish a session key and secure an encrypted channel between the servers using standard cryptographic techniques as is well known in the art. The key used might depend on the user password used for access. The secure tunnel from authentication server 114 to signature server 104 continues into the hardware part of the signature server 104, in the sense that the keys used for this tunnel are controlled by tamper resistant hardware and never appear in the clear outside the certifying apparatus. The integrity of the system does not then have to rely so much on the secure area in which the server is placed. The same applies for all communication to and from both the signature server 104 and authentication server 114.

The authentication server 114 distributes authentication challenges to user devices 102 through an alternate channel 126. In one embodiment, the alternate channel 126 employs SMS (short message service) messages sent via a cellular network for mobile phones for communicating the authentication challenges. In another embodiment, it may be an app that generates an OTP on the mobile device based on a shared key with the Authentication Server, which allows the Authentication Server to generate the same OTP and compare it to the received OTP. Regardless of whether the challenge has been received via the user device or generated by the user device 102, the response is sent back to the certifying device via the first channel 124. The response may be sent back to the authentication server 114 via the first channel, which then forwards it to the signature server 104 for authentication.

As mentioned above, generally speaking a user uses his user device 102 to contact the signature server 104 via the first channel 124. The signature server 102, via the secure link established between signature server 104 and authentication server 114, then instructs the authentication server 114 to send out an authentication challenge to the user device 102. The authentication server 114 may do this using SMS messaging, as described above, on the second channel 126. The authentication server 114 also provides the signature server 104 with the authentication challenge, via channel 124. For example, where the authentication challenge comprises two portions—a passcode and a key—the authentication server provides both portions to the signature server to enable response received from the device 102 to be verified.

In embodiments, part of the authentication challenge comprises a one-time password and the authentication server provides a derived version of the one-time password to the signature server. This derived version may be a hash value of the one-time password. The hash value is derived using a standard one way algorithm, such as SHA-1 (see Secure Hash Standard; FIPS Pub 180-1, 1995, National Institute of Standards & Technology, USA). A hash value is typically much smaller than the message from which it is so derived and, once the hash is calculated, the original message cannot be found from it. It is also very unlikely that two messages would have the same hash value. This hash of the one-time password is then compared with the hash returned by the device 102. Since the same standard hashing algorithm is used by both the authentication server 114 and the workstation 102, if the two hashes match then the user device is accepted as being authenticated by the signature server 104. Alternatively, another type of derived version of the password can be sent to the signature server 104. The requirement is only that the process used to derive the version of the password or token-response is the same in the authentication server 114 and user device 102 so that a password will give the same derived version as authentication server 114 and user device 102 but two different passwords will not give the same result.

The comparison of hash values allows the user device 102 to be verified while the signature server 104 never receives the actual one-time password.

The signature server 104 is supported by a tamper-resistant hardware security module (HSM) 106 which has a protected cryptographic facility, where keys and signatures are generated, and if keys are not in use then they are stored externally, encrypted under a master key. In an embodiment of the invention, initial data provided by the workstation 102 to the certifying apparatus is transferred to the HSM 106 via a channel set up using the password of the user device 102 and standard encryption techniques. A second layer of encryption 124 extends from the workstation to the certifying apparatus, but does not extend into the HSM 106. This is a strong encrypted link with the authentication of the server, and this channel carries further information regarding details of the user device 102 and specifying the authentication method to be used for the alternate channel 126. The main point is that no sensitive key ever appears in the clear outside the secure box. Such solutions are widely used by e.g. the banking environment, e.g. in connection with pincode-protection. The data store 108 records all information regarding administrators. The HSM 106 handles storage of keys and cryptographic functionality. The signature server 104 is protected both by a firewall 110 and by physical security 112 to prevent, reduce or deter unauthorised access.

The authentication server 114 is also enhanced by a hardware security module (HSM) 116, and has a database 118, in the same way as the signature server 104 and protected by a firewall 120 and physical security 122. In embodiments, the signature server 104 and authentication server 114 are geographically separated, and may each be operated by an independent body with separate clients administering each. This reduces the possibility that there will be unauthorised access to both servers, which would be required if the private key of the user were to be misused. Alternatively, the authentication server 104 and signature server 114 may be housed in the same certifying apparatus. In such a case the administration clients for each server (e.g. the interface through which the server is operated) should preferably remain separate, so that increased security is provided, by ensuring that access to both servers cannot be obtained through the same client, although they could be the same. The advantage of this single-server approach is that this approach is simpler, as only one server is operated rather than two, but the disadvantage is that more care is required to assure that the trusted personnel cannot thwart the system in any way.

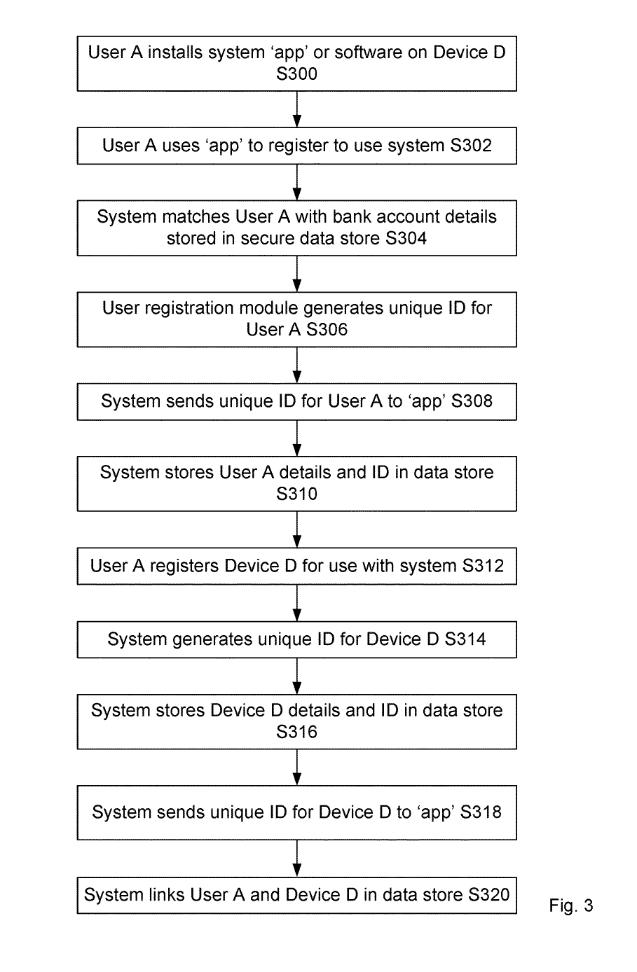

As mentioned above, in order to use the secure system 10, a pre-defined relationship between a user and his device must be created and stored within the secure backend payment system 26. The pre-defined relationship links a user to his computing device(s), and a second pre-defined relationship links the user to his bank account details stored within the secure data store 34 of the secure backend. FIG. 3 is a flow chart of example steps for a user to register to use the secure payment system of FIGS. 2a and 2b. User A may be registered in the system by the issuer of his bank card based on User A's credentials (as known by the issuer/bank). These credentials may include User A's bank account details and a unique ID that can be recognised by the components of the secure payment system, and which can be communicated between the user, the physical or online shops, and the user's one or more personal computing devices. User A may be asked to answer a number of security questions either by his bank, or when using the secure system for the first time. These answers, or a value associated with these answers, may be used to verify the user during a subsequent transaction. The secure backend also stores details of one or more virtual debit- or credit cards that are registered in the user's name. Advantageously, these details may be supplied to the backend data store via User A's bank card issuer, so that User A does not ever have to enter these details when registering to use the secure payment system (thereby reducing the risk that his details may be intercepted during the registration process).

Thus, User A's details (e.g. name, address, bank account number) are preferably known to the secure backend and stored within the secure data store. When User A registers to use the secure payment system, he does not need to enter his banking details as part of the registration process, but merely identify himself. During the registration process, the one or more processors in the secure backend payment system map User A to his details already held within the system. To register to use the system, User A may be required to download and install software or a software application (‘app’) on his computing device D (step S300). Once installed, User A uses the app to register himself to use the system (S302), by for example, providing information that the secure backend can use to map User A to the details already held about him within the system. For example, User A may be required to enter certain digits of a pre-defined passcode or answer a security question, so that the system can work out who is attempting to enrol into the system for the first time. This initial enrolment or registration process may only happen once, and may require a user to enter a minimum set of personal details in order to be mapped to the details held in the system. The app transmits these details from the computing device D to the secure backend.

The details transmitted from the computing device D to the secure backend payment system may be encrypted. In this case, when the software app is initialised or turned on for the first time and connects to the payment system via the Internet (first channel), the app may receive a shared secret cryptographic key from the secure backend payment system via an SMS message or otherwise (second channel). The key is secret because the SMS channel is assumed to be secure. This shared key may be requested by the app from the secure backend payment system during the initialisation phase, and the key is returned to the app via a second channel (e.g. via an SMS message). The key is extracted from a message received from the secure backend by the app and used to encrypt User A's registration details. The app then transmits the encrypted details together with the key to the secure backend. The secure backend decrypts the information with the shared key securely stored within the system, extracts User A's details and maps them to User A's details and bank account information securely stored within the system. User A is then registered as an active user of the system.

As mentioned earlier, Device D is a computing device (preferably a mobile computing device) that is able to connect to the internet and to e-mail servers, as well as to connect to local networks using e.g. NFC or Bluetooth. Device D optionally has some access control for User A to log on and execute code on the device. On each device some authorisation software is installed for communication with the secure backend (e.g. in the form of an app) that may share or register an individual key with/in a secure backend belonging to the bank that issues User A's bankcard. The key allows secure communication between the backend and the device at the entire control of the user.

The user registration module within the system matches the details received from User A to his bank account details stored in the secure data store (S304). Thus, User A does not need to provide all the details written on his bank card to the system during the registration process, and once registered, does not need to enter the details written on his bank card when making transactions using the secure payment system. User A's bank details may only be obtained by a malicious third party if the secure back end of the secure payment system is breached.

Once User A has been matched to his stored bank details, the user registration module generates a unique ID for User A (S306). In embodiments, the unique ID is generated, by the user registration module, or a pre-defined unique ID for User A (e.g. pre-defined by the bank card issuer) is extracted from the secure data store of the secure back end. The unique user ID is transmitted to the ‘app’ running on Device D and stored on Device D for use by the app (S308). For example, when the app is used to make a transaction, the user ID may be included in data communicated to the secure backend, in order for the system to determine which registered user is attempting to make a transaction. The secure payment system stores the unique ID with the rest of User A's details in the secure data store (S310), so that User A's details can be retrieved quickly during subsequent transactions.

User A is also required to register his Device D for use with the system (S312). As mentioned earlier, a strong relationship between User A, Device D and the secure system is created in order to process and authorise transactions. User A may use the same ‘app’ to register his Device D, where the app may communicate details about the Device D to the system to identify the device. The device registration module of the secure payment system generates a unique ID for Device D (S314) and stores this with any other details about Device D in the data store (S316). The unique device ID is transmitted to the app running on Device D (S318) and stored on the device for use by the app in subsequent transactions. The system also links User A and Device D (preferably using the unique IDs of the user and device), and stores this relationship in data store S320. Thus, the system has now linked a user to his bank details and the user to the device he intends to use to perform transactions. These relationships are stored within the secure backend and used to verify any subsequent transactions.

The steps to register a computing device within the system may be repeated to allow a user to register more than one personal computing device. For example, the user may wish to register his smartphone and his home PC, so that he can perform transactions using both devices. Preferably, the system creates and stores separate relationships between a user and each of his registered devices, i.e. User A and Device D, User A and Device E, User A and Device F, and so on. The device registration process may require the user to specify the type of device being registered, e.g. laptop, PC, smartphone, so that the system can use the appropriate communication channels to communicate with the device. For example, if Device E is a smartphone and Device F is a laptop, the system may use email and SMS messages to communicate with Device E, but only email with Device F. Thus, if a device is able to connect to the mobile communication networks, the user is required to enter the mobile phone number associated with the device during the registration phase.

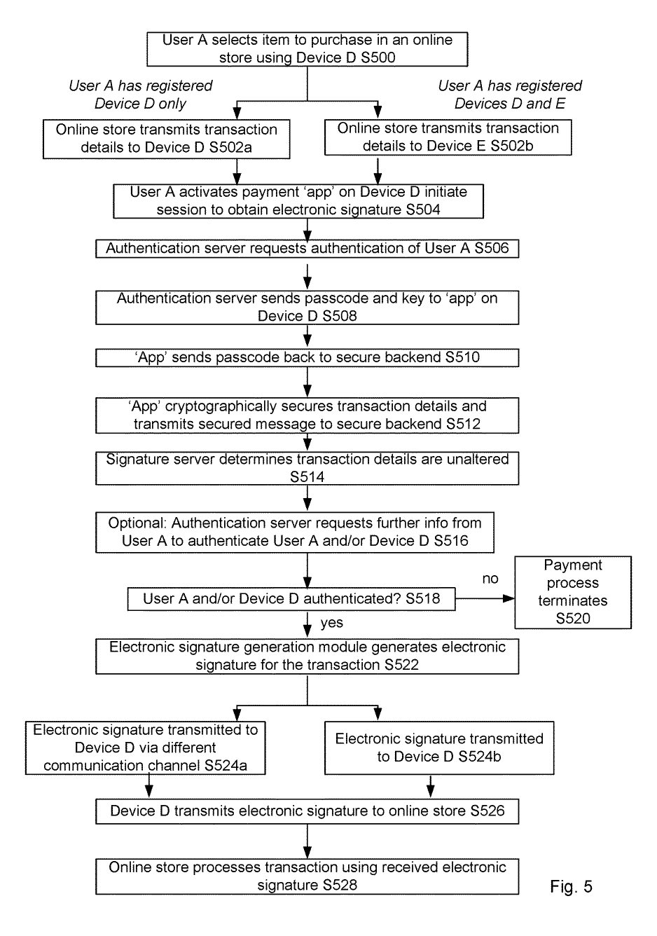

Two example scenarios of how a registered device can be used to perform a transaction using the secure system are now described with reference to FIGS. 4 and 5.

### Example 1: In Store Transaction

FIG. 4 is a flow chart of example steps to make a purchase in a physical store, i.e. the steps to perform a transaction using a mobile computing device at a point of sale terminal in a store. User A and his Device D have been pre-registered in the secure payment system, as described above. User A selects an item or service to purchase (S400). Rather than paying for the item with a physical debit or credit card, User A uses his Device D to make the transaction, thereby avoiding the need to enter the details written on his debit or credit card at any point during the transaction.

Details about the item User A wishes to buy are communicated to Device D. This may be by using Device D to scan the item's barcode, 2D barcode or other identifier, and then to extract the details about the item from this barcode (S402b). User A is required to confirm the extracted transaction details about the item (e.g. price of the item) are correct on Device D (S404b). Alternatively, the store may scan the item's barcode using a barcode scanner, extract the details about the item from the barcode and transmit these to a point of sale or other computing terminal (S402a). User A confirms the transaction details on the point of sale terminal (S404a), and then the terminal transmits the confirmed transaction details to Device D (S406), e.g. via short range communication protocols such as a Bluetooth® or near-field communication.

The transaction details are now on Device D, and User A progresses the transaction by activating the software or ‘app’ on Device D to start a payment session using the secure backend payment system (S408). When the app is turned on or activated, a session is initialised and the app contacts the authentication server in the secure backend payment system. This initial contact starts the transaction process and triggers the authentication server to request authentication information from the user and device. As explained above, both a user and the device must be authenticated in order for a transaction to be processed. In particular, it is important to verify that the session has been initiated on a registered device, and that the transaction details subsequently sent to the secure backend are sent by the registered device and are not altered during transmission. That is, two responses are preferably required from a registered device in order to verify the device and the transaction information.

### i) User Authentication

When User A activates or turns on the secure payment system app running on Device D, the user may be required to authenticate himself, prior to forwarding any transaction details to the secure backend (S410). Alternatively, the user authentication may be performed after the device authentication is completed. For example, the authentication server may request User A to enter specific characters of a shared secret (passcode) to authenticate himself. In preferred embodiments, the user is contacted by the authentication server via a second channel, e.g. via email or a computerised phone call, in which the user is asked to indicate in some manner that he intends to perform a transaction. In the case where the user authentication is performed after the device authentication (S420), the email or phone call may contain details of the transaction (e.g. vendor, amount, etc.), ask the user whether he accepts or rejects the transaction (e.g. by verbally saying ‘yes’ on the phone call to accept, or keying in ‘1’, etc.), and ask for the user to divulge certain characters of a shared secret. The shared secret is important because if the Device D is in a fraudster's hands, the transaction may only progress if a secret, known only to User A, is provided to the system.

Advantageously, the user is contacted for his passcode and/or approval of the transaction via a separate channel to the channel used to connect to the secure backend payment system. Even if Device D has been stolen, the transaction requires the secure passcode to be provided.

In embodiments, the passcode may be replaced by or may comprise User A's biometric information (e.g. finger print or image of his iris). This information is stored in the secure data store in the secure backend payment system. The secure system may be configured to receive images of finger prints or irises from a user, and to compare the received images against those held in the secure system.

### ii) Device Authentication & Remote Electronic Signature Generation

In the case where Device D is a smartphone (i.e. a computing device able to connect to the mobile communication network), the user either uses a web browser for online shopping, or uses the device to receive the transaction details in store (as described above). The user initialises the application software on his smartphone to begin a session with the authentication server of the secure backend payment system (S408). Typically, the app connects to the secure backend payment system via the internet (first channel). The system preferably authenticates the device prior to accepting or processing any transaction details received from the device. The device authentication is a two-step process: firstly, the system verifies that the transaction request is coming from a registered device and not a spoof account, and secondly, the system verifies that the transaction request has been cryptographically secured using the correct secret key and that the transaction details have not been altered during transmission (e.g. via a man in the middle attack). These two steps are described below.

When the authentication server receives a message (or data) from the smartphone indicating the user wishes to process a transaction, the authentication server generates, in particular embodiments, an SMS message (or similar) and sends this to the smartphone via an SMS gateway (second channel). The SMS message comprises a short authentication code (or passcode), and a shared key such as a strong triple-DES or AES key (S412).

The short authentication code may be 4 to 6 digits in length. This code is extracted from the SMS message by the app running on Device D, and sent back to the authentication server by the first channel (i.e. via the Internet) (S414). If the received code matches the authentication code sent by the authentication server, the authentication system determines that Device D is the device which has initiated the session with the secure backend payment system. (In embodiments, and as described above, the authentication server may simply forward the authentication code to the signature server, and when a response is received from Device D, the authentication server may forward the response to the signature server, such that the signature server determines if the response matches the code.) That is, the authentication server determines that the request to begin a transaction has arrived from a registered device and not a spoof account, because a spoof account generally speaking cannot return the authentication code back as it would not have received the authentication code in the first place.

Once the system has verified that the transaction request is coming from a registered device and not a spoof account, the system requests the transaction details from the application running on the computing device. Alternatively, the system may request the passcode and transaction details to be returned to the authentication server simultaneously. In embodiments, the software app extracts the cryptographic key received from the authentication server in the SMS message. The software application applies a MAC algorithm (message authentication code) to the transaction details using the key, and outputs a MAC. The software app transmits both the transaction details (e.g. in a plaintext message) and the MAC to the authentication server (which forwards both to the electronic signature generation module), or to the electronic signature generation module directly (S416). In parallel, the authentication server forwards the strong, secret key to the electronic signature generation module. The electronic signature generation module verifies the received MAC, by applying the key it received from the authentication server to the plaintext transaction details and comparing the resulting MAC to the received MAC. If the MACs are the same, the transaction details are verified as being generated by the registered device D and as being unaltered during the transmission (S418). As mentioned earlier, the authentication server does not generally perform the authentication/verification of the transaction details—this is performed by the electronic signature generation module (or signature server). Thus, it is implicit that the transaction is for User A (since Device D is linked to User A), and the authentication server may map the transaction to the account details held for User A in the secure data store. If User A has multiple bank accounts and multiple virtual bank cards he could use for the transaction, the authentication server may ask the user to specify which card he wishes to use for the transaction.

Additionally or alternatively, the app applies a different cryptographic technique to the transaction details. For example, the app may encrypt the transaction details and transmit the encrypted data in a message to the secure backend of the payment system (S416). Alternatively, the details in the message may be cryptographically secured using e.g. a key hash value, an encrypted hash value or another cryptographic technique.

The device verification may be followed by a user authentication step (S420), as mentioned above, and/or by a step that requires a user to confirm the transaction details extracted by the electronic signature generation module. This confirmation step may comprise sending an e-mail (second channel) to User A that lists the details of the transaction, and for higher risk transactions, may additionally comprise a computerised call to the user where the details are read out. The user must then indicate in some manner that he accepts the transaction, e.g. by saying “yes”, or keying “1” or something more elaborate. If the User does not confirm the transaction or pass the further authentication step (S422), the payment process terminates (S424). Otherwise, the electronic signature generation module generates the appropriate payment scheme authorisation code (e.g. a digital signature) for the transaction (S426). The authorisation code may be forwarded directly to the POS terminal in store (S428a) or to the Device D (S428b) which then transmits the details to the POS terminal (S430). Whichever method is used, the electronic signature is provided to the POS terminal and this is used to complete the transaction (S432). Alternatively, the electronic signature may be forwarded directly to the bank of the shop (i.e. the ‘acquiring’ bank) or to the POS terminal directly from the electronic signature generation module.

Any attack on this payment process will need to involve the phone as well as the channel used to connect to the payment system (e.g. the Internet). That is, the system is not prone to a “phone not present” attack. If a transaction session is started by someone other than the rightful owner of Device D, the phone would receive the SMS (if the SMS approach was used), and it will be stuck there. Unless the phone has been handed over or stolen, there is no attack. In other words, any attack would have to be an attack on the phone using malicious software. The only way an attack could be successful is if it is a different transaction than the intended that is being authorised, but in this case, it could be caught by call-back option described above, which requires the user to verify the transaction details.

Advantageously, there are no changes to the payment scheme whatsoever since the POS terminal receives an electronic signature to process a payment which resembles the signature generated by an EMV card. Furthermore, no hardware modifications to the smartphone or computing device are required to implement the payment scheme.

In the case that Device D is a tablet computer, laptop or PC, and User A has also registered Device E with the system, where Device E is a smartphone, then the transaction details present on the tablet computer (first channel) can be verified on the smartphone (second channel), or vice versa. Thus, the authentication process requires both devices to be present, and Man in the Middle attacks are much less likely.

In the case where the user has only registered a single device with the system, and this is a tablet or other computing device (i.e. not a smartphone), then the system relies more heavily on the user authentication and confirmation processes. For example, the authorisation sever may be configured to send User A an e-mail with the details of the transaction, which User A must reply to with a “yes” or a “no” to confirm or reject the transaction. This exploits the fact that there are still two independent channels available—one via which the transaction is communicated to the secure backend payment system (the Internet), and one through which the transaction is confirmed and authorised by the user (e-mail or and app).

### Example 2: Online Transaction

FIG. 5 is a flow chart of example steps to make a purchase via an online store. In this scenario, User A uses a web browser on Device D to access the online store and to select an item to purchase (step S500). User A may only have registered Device D for use with the secure payment system—in this case, it preferably communicates with the online shop using one channel (e.g. email), and communicates with the secure backend payment system using a second channel to enhance security (S502a). If User A has registered two devices, D and E, for use with the secure payment system, the transaction details may be transmitted by the online store to Device E (used to select the item in the online store) and Device E transfers the details to Device D using a short range communication protocol such as Wi-Fi or Bluetooth® (S502b). User A then activates the payment software application on Device D to begin a transaction session (S504), as described above. In both cases, Device D is used to authenticate the transaction as described above, i.e. it receives the code and key described earlier (S508).

The software app on Device D transmits both the transaction details (e.g. in a plaintext message) and the MAC to the authentication server (which forwards both to the electronic signature generation module), or to the electronic signature generation module directly (S510 and S512). In parallel, the authentication server forwards the strong, secret key to the electronic signature generation module. The electronic signature generation module verifies the received MAC, by applying the key it received from the authentication server to the plaintext transaction details and comparing the resulting MAC to the received MAC. If the MACs are the same, the transaction details are verified as being generated by the registered device D and as being unaltered during the transmission (S514). Thus, it is implicit that the transaction is for User A, and the authentication server may map the transaction to the account details held for User A in the secure data store.

The device verification may be followed by a user authentication step (S516), as mentioned above, and/or by a step that requires a user to confirm the transaction details extracted by the electronic signature generation module. This confirmation step may comprise sending an e-mail (second channel) to User A that lists the details of the transaction, and for higher risk transactions, may additionally comprise a computerised call to the user where the details are read out. The user must then indicate in some manner that he accepts the transaction, e.g. by saying “yes”, or keying “1” or something more elaborate. If the User does not confirm the transaction or pass the further authentication step (S518), the electronic signature generation process terminates (S520). Otherwise, the electronic signature generation module generates the appropriate payment scheme authorisation code (e.g. a digital signature) for the transaction (S522).

The authorisation code may be forwarded back to Device D via the second communication channel (e.g. email) (S524a) if the user is only using one device. Alternatively, the electronic signature is transmitted to Device E which is being used to make the online purchase (S524b). Whichever method is used, the electronic signature is provided to the online vendor (S526) and this is used to complete the transaction (S528).

### Example 3: Online Transaction

As mentioned above, ‘card-not-present fraud’ is a problem for bank card issuers. This is because online transactions (a typical example of a ‘card not present’ transaction) requires many of the details on a bank card to be provided to the online vendor to complete the transaction, such as the Primary Account Number (PAN) of the payment card, the name of the bank account holder, the expiry date of the card, and the last three digits of the CVV/CVC/CSC (card verification value/card verification code/card security code usually printed on the back of a payment card). In other words, card not present fraud is a problem because online transactions require these card details to be entered and once they are copied by a fraudster, they can be used to make fraudulent transactions (repeatedly).

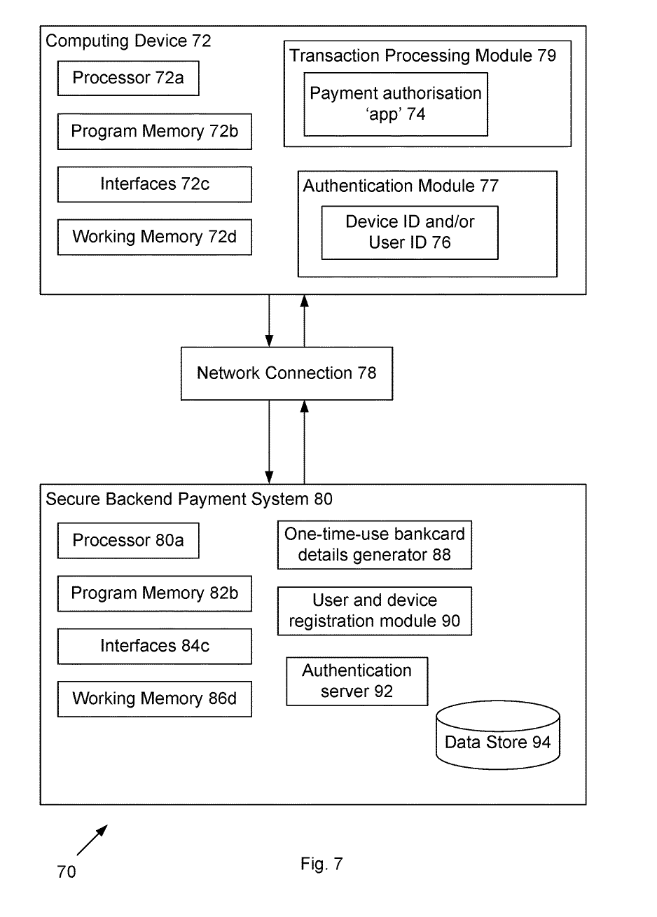

FIG. 7 is a block diagram of a system 70 to process secure payments made with respect to an online store in a further embodiment of the present invention. A user uses a computing device 72 to perform transactions online. The computing device may be a PC or preferably, a mobile computing device, such as a laptop, smartphone, tablet-PC, etc. The computing device comprises a processor 72a coupled to program memory 72b storing computer program code to implement the backend payment method, to working memory 72d and to interfaces 72c such as a screen, keyboard, mouse, touchscreen, and network interface.

The processor 72a may be an ARM® device. The program memory 72b, in embodiments, stores processor control code to implement functions, including an operating system, various types of wireless and wired interface, storage and import and export from the device.

The computing device 72 comprises a user interface to enable the user to confirm transactions. A wireless interface, for example a Bluetooth®, Wi-Fi or nearfield communication (NFC) interface is provided for interfacing with other devices and/or the secure backend payment system 80.

The computing device 72 comprises payment authorisation software, preferably in the form of a software application (‘app’) 74. A user is preferably required to turn on the payment authorisation app 74 when initiating a transaction session using the secure system 70. The payment authorisation app 74 is a part of a transaction processing module 79. The computing device 72 also comprises a device ID 76, which uniquely identifies the device, and is used to define the relationship between user and device which is stored within the system. The device ID 76 may be the unique ID associated with the hardware-based computing device 72, and/or if the computing device is able to connect to a mobile communication network, the device ID may be the subscriber identity module (SIM) which identifies the device on the mobile network. As such, the computing device comprises an authentication module 77 which is configured to receive the authentication information and generate the first and second authentication identifiers.

The computing device 72 may be used by a user to perform an online transaction through, for example, web browser software running on the device. The transaction details of a particular transaction being performed by the user using the computing device 72 are forwarded to a secure payment backend server 80 via the network connection 78.

The secure backend payment system 80 comprises at least one processor 80a coupled to program memory 80b storing computer program code to implement the backend payment method, to working memory 80d and to interfaces 80c such as a network interface. The secure backend payment system 80 comprises a one-time-use bankcard details generator 88, a user and device registration module 90 and an authentication server 92. The one-time-use bankcard details generator 88 is used to generate single use (and time-limited) bankcard details which can be entered into the online vendor's payment webpage to complete a transaction. The one-time-use bankcard details are not the same as the bankcard details of User A, but are virtual details generated for User A for a specific transaction and which are linked to User A's real account (so that the monetary transfer is made from User A's account). Thus, User A can provide the online vendor with the standard details required to perform online transactions (i.e. the PAN, expiry date and CSV code), but without revealing his own, real card details.

The user and device registration module 90 is used to create the strong binding or secure authorisation token between a user and user device(s), as mentioned above. Once this relationship between user and user device is defined in the registration module 90 (and stored in a data store 94), the relationship can be used to authorise subsequent transactions. This authorisation is performed by the authentication server 92, which checks whether a registered user is attempting to make a transaction on his registered device. The authentication server may perform this check by referring to the pre-defined data held for the user in the data store 94. The authentication server may perform additional authentication checks to confirm the user's identity, as will be described in more detail below, where such additional checks may also be pre-defined for the user in the data store 94.

Thus, embodiments provide a way to identify a user and his computing device properly, as well as ways to prevent Man-in-the-Middle′ or ‘Man-in-the-Browser’ attacks where parts or all of the transaction data forwarded by the user are altered by a third party. Typically, the steps to prevent such attacks comprise an initial ‘verification’ protocol that establishes whether the device being used to perform a transaction is a registered device belonging to a registered user, and that the device is being used by someone who knows some secrets that are shared between the registered user and the backend authentication server. This initial step is generally followed by creating a session in which the user forwards the details of a transaction to the secure backend payment system and authorises the transaction to be completed. Preferably, once the user and user device have been authenticated, the virtual, one-time-use bankcard details are then returned to the user device to enable the transaction to be completed, as described above for example 2.

As shown in FIG. 7, the computing device 72 may comprise a device ID 76 which is used to identify the device. There are a number of ways of identifying a computing device or mobile computing device, e.g. using cookies and device IDs. Similarly, there are a number of methods for identifying a user, as described above.

Data may be transferred from the computing device 72 to the secure backend payment scheme 80 (via the network connection 78) for authorisation in a number of ways. In one realisation, if a smartphone is used, the transaction could just be forwarded in plaintext, and if the monetary amount is above a certain limit, a computerised call back could take place where the most important details are read to the user together with an authorisation code that he then keys in on his computing device 72. Alternatively, the transaction data could be forwarded in a cryptographically secured form using an appropriate key which was provided to the computing device 72 by the secure backend payment system 80.

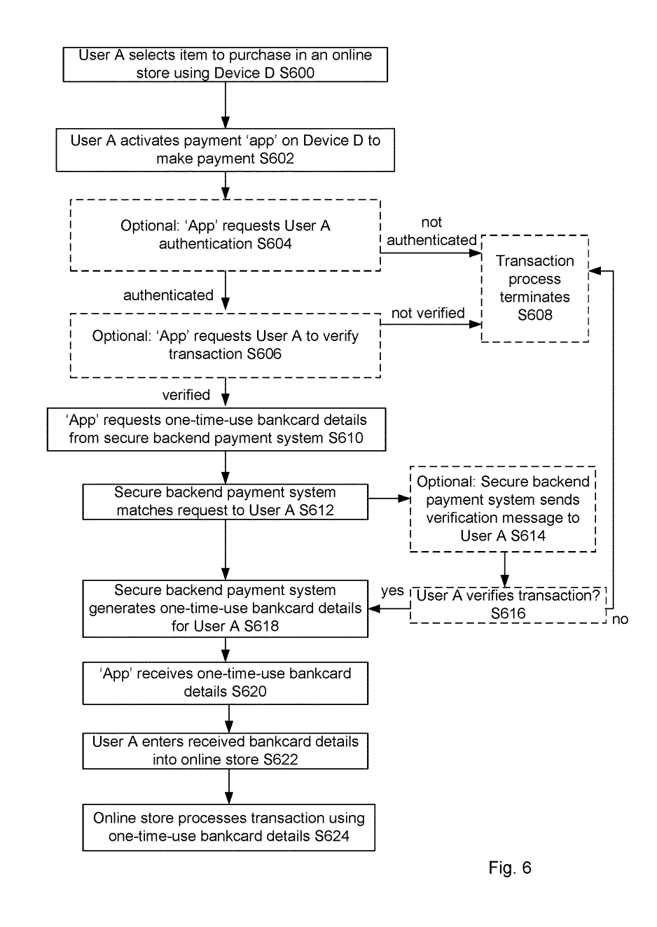

Turning now to FIG. 6, this is a flow chart of example steps to make a purchase in an online store using the virtual, one-time-use bankcard details. User A has pre-registered their Device D with the secure payment system as previously described. User A uses a web browser on Device D to browse an online store and select an item to purchase (S600). User A activates a payment application (‘app’) on Device D to begin a transaction session between the device and a secure backend payment system (S602).

Optionally, the app may request User A to authenticate itself to the system (S604), by for example, using the methods described earlier. Optionally, the app may request User A to verify the transaction (S606), by for example, using the methods described earlier. In each case, if User A is not authenticated, or User A does not verify the transaction, the process terminates (S608).

If verified and authenticated, the app requests one-time-use bankcard details from the secure backend payment system (S610). The authentication server preferably verifies the request is coming from a registered device, by performing the device authentication steps described earlier. The authentication server also determines the user linked to the device D from which the request originates, in order to link the transaction to the correct bank account holder (S612). Optionally, the authentication server may send a verification message to User A to request confirmation that the request originates from User A as well as Device D (S614), e.g. by sending User A an email or making a computerised phone call to User A, as described earlier. If the request is verified (S616), the one-time-use bankcard details generator generates the requested details for User A (S618). The generated details include a virtual PAN, expiry date and CVV. These virtual, one-time-use details are sent back to the app by the generator (S620), preferably by a second channel (e.g. via an SMS message or email), and not the first channel used to connect Device D to the system (e.g. the Internet).

The user then enters the received bankcard details into the online store (S622), or the app may be configured to extract the received details from the SMS message and auto-complete the fields in the online store's payment webpage. The online vendor then uses the one-time-use bankcard details (S624) to compete the transaction. Since the one-time-use bankcard details are linked to User A's real bank details, when the one-time-use details are forwarded by the online vendor to the originating bank, the originating bank can transfer the monies from the real bank account by mapping the virtual details to the real account details. However, this mapping is performed in the bank's secure backend and the online vendor never receives User A's real bank account details.

For further security, the one-time-use bankcard details are preferably only valid for a short period of time, e.g. 5 minutes or 60 seconds, and are only valid for the specific transaction for which they were generated. The issuing bank may be able to define rules denying transactions which are not either of:
1. card-present transactions (using an EMV chip card, or as a fall-back, the magnetic stripe on the card); or
2. card-not present transactions (in which case, only one-time-use virtual card details are accepted)

The secure backend payment system retains used and expired one-time-use virtual card details, alongside the monetary amount of the transaction associated with the virtual card details for a certain period. This enables the system to process charge-backs, e.g. cancelled transactions, or rather, an inverse transaction.

Additionally, the issuer/bank may include fraud-prevention involving the active participation of the cardholder: The system can be further improved by notifying the cardholder about the transaction through messaging (say, push message to the app, email, instant messaging, SMS, telephone call, etc. including recourse instructions for cardholders who feel this happened in error. Furthermore, as described above, the user may be required to confirm a transaction orally, e.g. by reading out a message sent to the user via email or SMS. The message may be related to the user and the transaction being performed, e.g. “This is Matt and I wish to use my card with American Airlines/for 227 dollars/and I am presently in California”. This may require using voice recognition software to further authenticate the user.

No doubt many other effective alternatives will occur to the skilled person. It will be understood that the invention is not limited to the described embodiments and encompasses modifications apparent to those skilled in the art lying within the spirit and scope of the claims appended hereto.

1. A method of generating a secure transaction on behalf of a user having a user device, the method comprising:
using authentication information to authenticate the user device, the authentication information comprising a first portion for authenticating the user device and a second portion for authenticating a message from the user device;
receiving a request from the user device to initiate a secure transaction via a first communication channel;
receiving a first authentication identifier from the user device wherein the first authentication identifier is based on the first portion of the authentication information;
receiving a message comprising transaction details from the user device via the first communication channel;
receiving a second authentication identifier from the user device wherein the second authentication identifier is based on the message and the second portion of the authentication information;
determining whether the first and second authentication identifier are authentic and only if both authentication identifier are authentic; the method further comprises:
generating secure information which is unique to the user for the secure transaction; and
outputting the secure information whereby the secure information is used secure the secure transaction.

2. The method according to claim 1, wherein the authentication information is an authentication challenge, the method further comprising:
generating the authentication challenge, in response to the request from the user device;
sending the authentication challenge to the user device via a second communication channel which is different to said first communication channel;
receiving a first response to the authentication challenge from the user device wherein the first response is the first authentication identifier; and
receiving a second response to the authentication challenge from the user device wherein the second response is the second authentication identifier.

3. The method according to claim 1, further comprising:
registering the user device to provide the user device with the authentication information before receiving the request from the user device.

4. The method of claim 1, wherein the second portion is a shared cryptographic key and wherein the second authentication identifier is a message authentication code which is generated by the user device by applying the shared cryptographic key to the message.

5. The method of claim 4 further comprising determining whether the second authentication identifier is authentic by:
applying the shared cryptographic key to the received message to generate a message authentication code
comparing the generated code to the received code and
determining the second authentication identifier is authentic when the codes match.

6. The method according to claim 4, comprising generating a shared cryptographic key which is a strong triple-DES or AES key.

7. The method according to claim 4, comprising generating a shared cryptographic key which comprises a key hash value or an encrypted hash value.

8. The method of claim 1, wherein the first portion comprises a passcode.

9. The method of claim 2, wherein the first response is the passcode, the method further comprising determining whether the first response is authentic by comparing the received passcode with the sent passcode, thereby determining the request originated from the user device when the received and sent passcodes match.

10. The method of claim 3, wherein the first authentication identifier is a one-time-password generated based on the passcode, the method further comprising determining whether the first authentication identifier is authentic by regenerating the one-time-password from the passcode, comparing the regenerated one-time-password with the received one-time-password, thereby determining the request originated from the user device when the one-time-passwords match.

11. The method of claim 1 further comprising sending a verification message to the user prior to generating the secure information for the secure transaction, wherein the verification message comprises the received transaction details.

12. The method of claim 11 wherein sending the verification message comprises sending the message to a second user device.

13. The method of claim 1 comprising generating an electronic signature as the secure information.

14. The method of claim 1, comprising generating virtual card details as the secure information.

15. The method as claimed in claim 14 further comprising linking the virtual card details to a bank account for the user and the secure transaction being performed.

16. The method as claimed in claim 14 wherein the virtual card details are valid for a pre-set time period, the method further comprising sending the pre-set time period to the user device with the virtual bankcard details.

17. The method of claim 1 wherein outputting comprises sending the secure information to the user device via the second communication channel whereby the user device uses the secure information to perform the secure transaction.

18. A carrier carrying computer program code which when running on a computer causes the computer to carry out the steps of claim 1.

19. A secure backend payment system for generating a secure transaction on behalf of a user having a user device, the system being configured to:
use authentication information to authenticate the user device, the authentication information comprising a first portion for authenticating the user device and a second portion for authenticating a message from the user device;
receive a request from the user device to initiate a secure transaction via a first communication channel;
receive a first authentication identifier from the user device wherein the first authentication identifier is based on the first portion of the authentication information;
receive a message comprising transaction details from the user device via the first communication channel;
receive a second authentication identifier from the user device wherein the second authentication identifier is based on the message and the second portion of the authentication information;
determine whether the first and second authentication identifier are authentic and only if both authentication identifier are authentic; the method further comprises:
generate secure information which is unique to the user for the secure transaction; and
output the secure information whereby the secure information is used secure the secure transaction.

20. The system as claimed in claim 19 further comprising a data store storing pre-defined relationships between each user and their user device.

21. The system as claimed in claim 19 further comprising a second user device which is configured to:
receive a verification message prior to the authentication server generating the secure information for the secure transaction, and
generate a response to the verification response.

22. The system as claimed in claim 19, comprising an authentication server which is configured to:
generate an authentication challenge, in response to the request from the user device;
send the authentication challenge to the user device via a second communication channel;
receive a first response to the authentication challenge from the user device, wherein the first response is the first authentication identifier;
receive the message comprising transaction details from the user device via the first communication channel;
receive a second response to the authentication challenge from the user device, wherein the second response is the second authentication identifier;
determine whether the first response authenticates the user device and whether the second response authenticates the message; and
if so, forward the message to a signature server.

23. The system as claimed in claim 19, comprising an authentication server which is configured to:
register the user device with the authentication server to provide the user device with the authentication information before receiving the request from the user device;
receive a request from the user device to initiate a secure transaction via first communication channel;
receive the first authentication identifier from the user device;
receive the message comprising transaction details from the user device via the first communication channel;
receive the second authentication identifier from the user device;
determine whether the first authentication identifier authenticates the user device and whether the second authentication identifier authenticates the message; and
if so, forward the message to a signature server.

24. The system as claimed in claim 19, comprising a signature server which is configured to:
generate the secure information which is unique to the user for the secure transaction; and
output the secure information whereby the secure information is used to secure the secure transaction

25. The system as claimed in claim 19, further comprising a user device comprising:
a user interface for displaying a message comprising details of a transaction to the user;
a transaction processing module for initiating a secure transaction session between the computing device and the third party on a first communication channel; and
an authentication module configured to:
receive the authentication information and
generate the first and second authentication identifiers.
